(19) United States
(12) Patent Application Publication
(10) Pub. No.: US 2025/0330332 A1
(43) Pub. Date: Oct. 23, 2025

(54) SYSTEMS AND METHODS FOR EPOCH-DRIVEN RESOURCE DISTRIBUTION USING VIRTUALIZED COMPUTATIONAL POWER METRICS ASSOCIATED WITH UNIQUE DIGITAL OBJECTS

(71) Applicant: NFT Loyalty Systems, LLC, Potomac Falls, VA (US)

(72) Inventors: Keith Pitcher, Benton Harbor, MI (US); Jon Miles, Potomac Falls, VA (US)

(73) Assignee: NFT Loyalty Systems, LLC, Potomac Falls, VA (US)

(21) Appl. No.: 19/185,180

(22) Filed: Apr. 21, 2025

Related U.S. Application Data
(60) Provisional application No. 63/636,548, filed on Apr. 19, 2024.

(51) Int. Cl. H04L 9/32

(52) U.S. Cl. CPC H04L 9/3247

(57) ABSTRACT

A distributed computing system is described herein. The system includes a distributed ledger with a plurality of peer computing nodes executing a consensus protocol and maintaining a replicated application state. An executable module receives a cryptographically signed request from an external entity to associate a unique digital object with a memory address. In response, a metadata transformation API retrieves static metadata, generates mutable metadata including a virtualized computational power metric, and stores it on the ledger. The system records a resource allocation state for the digital object based on the metric and total network power. A second signed request initiates a resource unit transfer, and the system updates a total transferred amount based on the allocation state. The system enables operating digital objects to extract resources in proportion to their assigned computational contribution.

### CROSS-REFERENCE TO RELATED APPLICATIONS

This application claims the benefit of U.S. Provisional Application No. 63/636,548, filed on 19 Apr. 2024, which is incorporated in its entirety by this reference.

### TECHNICAL FIELD

This invention relates generally to distributed computing systems and, more specifically, to systems and methods for allocating computational resources and recording associated state transitions on a distributed ledger using digital objects associated with virtualized computational power metrics.

### BACKGROUND

Distributed ledger technologies, such as blockchain systems, enable peer-to-peer networks to maintain replicated state and enforce decentralized consensus over transaction histories. Traditional blockchain-based resource allocation mechanisms often rely on proof-of-work (PoW) or proof-of-stake (PoS) consensus algorithms. These models may generally rely on a continuous online presence, specialized hardware, or locked assets, which may limit participation to technically or economically privileged participants.

Unique digital objects, such as non-fungible tokens (NFTs) have emerged as units of ownership and identity within blockchain environments. However, these assets may generally be static in nature and may not be inherently associated with dynamic metrics or functions that would allow them to influence ledger-based resource allocation systems over time. The techniques described herein support improved mechanisms by which digital objects can be algorithmically associated with ledger-governed state variables that evolve based on system-defined parameters, such as block production intervals or aggregate system participation. Such mechanisms may support deterministic allocation of quantifiable resource units without reliance on real-time computational operations or centralized infrastructure.

### BRIEF SUMMARY OF THE INVENTION(S)

In some embodiments, a distributed computing system may comprise: a distributed ledger comprising a plurality of peer computing nodes executing a consensus protocol and maintaining a replicated application state; one or more computing devices implementing a metadata transformation application programming interface (API) that is in operable communication with the distributed ledger; and a deployed executable module stored at a first memory address on the distributed ledger and executed by the plurality of peer computing nodes via the consensus protocol, the deployed executable module comprising instructions that, when executed: receives, from an external signing entity, a first cryptographically signed request to associate a unique digital object with a second memory address on the distributed digital ledger, the second memory address derived from a public cryptographic key associated with the external signing entity; in response to the first cryptographically signed request, invokes, via an API function call, the metadata transformation API, wherein, executing the API function call, the metadata transformation API: retrieves static metadata associated with the unique digital object, transforms, in real-time, a virtualized computational power metric assigned to the unique digital object to mutable metadata for the unique digital object, and stores the mutable metadata on the distributed ledger in association with the unique digital object thereby designating the unique digital object as an operating unique digital object capable of extracting digital resources from the distributional ledger based on the virtualized computational power metric described in the mutable metadata; records, within the replicated application state, a resource allocation state for the unique digital object over a defined epoch interval, the resource allocation state representing an allocation value of a resource unit based on a proportion of the virtualized computational power metric relative to a total computational power metric associated with a plurality of digital objects; receives, from the external signing entity, a second cryptographically signed request to initiate a resource unit transfer process for the unique digital object, the second request including an indication of a quantity of resource units to transfer; and accesses, as part of the resource unit transfer process, the second memory address to update a total transferred quantity of resource units for the unique digital object based on the resource allocation state and the indicated quantity of resource units to transfer.

In some embodiments of the distributed computing system, the executable module is further configured to: receive, from the external signing entity, a third cryptographically signed request indicating an updated value of the virtualized computational power metric; modify the virtualized computational power metric with the updated value; and record, within the replicated application state, a second resource allocation state for the unique digital object over a second defined epoch interval, the second resource allocation state representing a second allocation value of the resource unit based on a proportion of the updated virtualized computational power metric relative to a total computational power metric for the second defined epoch interval.

In some embodiments of the distributed computing system, the executable module is further configured to: store the updated value of the virtualized computational power metric as a pending value within the replicated application state; and verify that each resource unit allocated to the unique digital object in one or more epoch intervals preceding the second epoch interval have been transferred, wherein modifying the virtualized computational power metric with the updated value is based on the verifying.

In some embodiments of the distributed computing system, the executable module is further configured to: receive, from the external signing entity, a third cryptographically signed request designating a secondary memory address as a designee address for the unique digital object; store the designee address within the replicated application state in association with the unique digital object; receive, from the external signing entity, a fourth cryptographically signed request to initiate an additional resource unit transfer process for the unique digital object, the fourth request including an indication of a second quantity of resource units to transfer; and; access the designee address to update a total transferred quantity of resource units at the designee address for the unique digital object based on the indicated second quantity of resource units to transfer.

In some embodiments of the distributed computing system, recording the resource allocation state for the digital object comprises: storing, within the replicated application state, each of: a value of the total computational power metric for the defined epoch, a value of the virtualized computational power metric for the defined epoch, and a total quantity of resource units available for allocation during the defined epoch.

In some embodiments of the distributed computing system, the executable module is further configured to: retrieve the resource allocation state from the replicated application state based at least in part on receiving the second cryptographically signed request; determine a quantity of resource units available for transferring based on the value of the total computational power metric, the value of the virtualized computational power metric, and the total quantity of resource units available; and record, within the replicated application state, a portion of the available quantity of resource units that are transferred as part of the resource unit transfer process based on the quantity of resource units indicated in the second request.

In some embodiments of the distributed computing system, the executable module is further configured to: determine, based on the unique digital object becoming associated with the virtualized computational power metric during the epoch, a corresponding participation duration, wherein the quantity of resource units available for transferring is based at least in part on a ratio of the participation duration to a total duration of the epoch.

In some embodiments of the distributed computing system, the replicated application state comprises a respective value of the virtualized computational power metric for each of a plurality of unique digital objects associated with the defined epoch, and wherein the executable module is further configured to: determine, for each unique digital object of the plurality of unique digital objects, a respective quantity of resource units available for transferring; sum the respective quantity of resource units for each unique digital object of the plurality of unique digital objects to obtain an aggregate quantity of resources available for transferring; determine a quantity of untransferable resource units based on a difference between the aggregate quantity of resources available for transferring and the total quantity of resources available for allocation during the defined epoch; and record, in the replicated application state, the quantity of untransferable resource units.

In some embodiments of the distributed computing system, the distributed computing system further comprises a second executable module deployed on the distributed ledger, and wherein: recording the resource allocation state comprises providing the resource allocation state to the second executable module; and the executable module is further configured to: retrieve, from the second execution module, the resource allocation state, wherein the resource unit transfer process is performed based at least in part on the retrieved resource allocation state.

In some embodiments of the distributed computing system, the second executable module is further configured to: store, for each unique digital object of a plurality of unique digital objects, a data record comprising state data for the unique digital object; store, for each defined epoch interval of a plurality of epoch intervals, a data record comprising state data for the epoch interval; respond to read requests from the executable module to retrieve state data associated with a specific unique digital object or a specific defined epoch; and retrieve and persist updates from the executable module.

In some embodiments of the distributed computing system, the distributed computing system further comprises a second executable module deployed on the distributed ledger, the second executable module configured to: receive and store digitally signed configuration update requests from a predefined set of authorized computing addresses; compare received configuration update requests to determine whether a threshold number of matching requests have been received for a particular configuration parameter; and transmit, upon determining that the threshold has been met, an instruction to modify one or more parameter values stored in the replicated application state.

In some embodiments of the distributed computing system, the distributed computing system further comprises a second executable module deployed on the distributed ledger, wherein the second executable module is configured to: receive a single digitally signed request comprising a batch of instructions for multiple unique digital objects; verify the authenticity of the request using a cryptographic signature matching a predesignated signer address; and decode and forward each instruction in the batch to the executable module for execution, each instruction including a digital object identifier and a corresponding operation type.

In some embodiments of the distributed computing system, the distributed computing system comprises a distributed application server operably coupled to the distributed ledger, the distributed application server configured to: receive digitally signed input data from external computing devices; construct and transmit one or more payloads to the executable module on the distributed ledger, the payloads formatted in accordance with the communication protocol of the distributed ledger and configured for execution by the peer computing devices; retrieve application state data from the distributed ledger by invoking read-only functions exposed by the executable module; and generate structured output data based on the retrieved application state.

In some embodiments of the distributed computing system, the distributed computing system further comprises a second executable module deployed on the distributed ledger, the second executable module configured to: generate a new unique digital object and associate the new unique digital object with a target address specified in the input data; transmit, to the executable module, data corresponding to the newly generated unique digital object, the data including an identifier of the unique digital object and an initial value of a virtualized computational power metric; maintain, within the replicated application state, the initial value of the virtualized computational power metric for each generated unique digital object; and provide, in response to a read request, encoded metadata for the unique digital object, the metadata comprising one or more attributes derived from values stored in the replicated application state.

In some embodiments of the distributed computing system, the consensus protocol is further configured to select a peer computing node for block generation based at least in part on a virtualized computational power metric associated with one or more unique digital objects registered within the system, wherein the executable module is further configured to: evaluate the virtualized computational power metrics of a plurality of unique digital objects maintained in the replicated application state; determine a weighted selection probability for each peer computing node based on its association with one or more unique digital objects; and transmit a selection signal to the consensus protocol to initiate block generation by the selected peer computing node.

In some embodiments, transforming the virtualized computational power metric to mutable metadata comprises: generating a structured metadata file that encodes the virtualized computational power metric in association with the unique digital object, wherein: the structured metadata file is formatted as a machine-readable data structure stored at a memory address distinct from the memory address of the unique digital object, and the executable module is configured to create a linkage between the memory address of the unique digital object and the memory address of the structured metadata file by recording a reference to the metadata address within the replicated application state.

In some embodiments, a computer-implemented method in a distributed computing environment, the method comprising: executing, by a plurality of peer computing nodes of a distributed ledger, a consensus protocol to maintain a replicated application state; receiving, by an executable module stored at a first memory address on the distributed ledger and executed by the plurality of peer computing nodes via the consensus protocol, a first cryptographically signed request from an external signing entity to associate a unique digital object with a second memory address on the distributed ledger, the second memory address derived from a public cryptographic key associated with the external signing entity; invoking, in response to the first cryptographically signed request and via an API function call, a metadata transformation application programming interface (API) in operable communication with the distributed ledger, wherein the invocation comprises: retrieving static metadata associated with the unique digital object; transforming, in real-time, a virtualized computational power metric assigned to the unique digital object into mutable metadata for the unique digital object; and storing the mutable metadata on the distributed ledger in association with the unique digital object, thereby designating the unique digital object as an operating digital object capable of extracting digital resources based on the virtualized computational power metric described in the mutable metadata; recording, within the replicated application state, a resource allocation state for the unique digital object over a defined epoch interval, the resource allocation state representing an allocation value of a resource unit based on a proportion of the virtualized computational power metric relative to a total computational power metric associated with a plurality of digital objects; receiving, from the external signing entity, a second cryptographically signed request to initiate a resource unit transfer process for the unique digital object, the second request including an indication of a quantity of resource units to transfer; and accessing, as part of the resource unit transfer process, the second memory address to update a total transferred quantity of resource units for the unique digital object based on the resource allocation state and the indicated quantity of resource units to transfer.

In some embodiments, the method may further comprise: receiving, from the external signing entity, a third cryptographically signed request indicating an updated value of the virtualized computational power metric for the unique digital object; modifying the virtualized computational power metric with the updated value; and recording, within the replicated application state, a second resource allocation state for the unique digital object over a second defined epoch interval, the second resource allocation state representing a second allocation value of the resource unit based on a proportion of the updated virtualized computational power metric relative to a total computational power metric for the second defined epoch interval.

In some embodiments, the method may further comprise: storing the updated value of the virtualized computational power metric as a pending value within the replicated application state; and verifying that each resource unit allocated to the unique digital object in one or more epoch intervals preceding the second epoch interval has been transferred, wherein modifying the virtualized computational power metric with the updated value is based on the verifying.

In some embodiments, a computer-program product comprising a non-transitory machine-readable storage medium may store computer instructions that, when executed by one or more processors, perform operations comprising: executing, by a plurality of peer computing nodes of a distributed ledger, a consensus protocol to maintain a replicated application state; receiving, by an executable module stored at a first memory address on the distributed ledger and executed by the plurality of peer computing nodes via the consensus protocol, a first cryptographically signed request from an external signing entity to associate a unique digital object with a second memory address on the distributed ledger, the second memory address derived from a public cryptographic key associated with the external signing entity; invoking, in response to the first cryptographically signed request and via an API function call, a metadata transformation application programming interface (API) in operable communication with the distributed ledger, wherein the invocation comprises: retrieving static metadata associated with the unique digital object; transforming, in real-time, a virtualized computational power metric assigned to the unique digital object into mutable metadata for the unique digital object; and storing the mutable metadata on the distributed ledger in association with the unique digital object, thereby designating the unique digital object as an operating digital object capable of extracting digital resources based on the virtualized computational power metric described in the mutable metadata; recording, within the replicated application state, a resource allocation state for the unique digital object over a defined epoch interval, the resource allocation state representing an allocation value of a resource unit based on a proportion of the virtualized computational power metric relative to a total computational power metric associated with a plurality of digital objects; receiving, from the external signing entity, a second cryptographically signed request to initiate a resource unit transfer process for the unique digital object, the second request including an indication of a quantity of resource units to transfer; and accessing, as part of the resource unit transfer process, the second memory address to update a total transferred quantity of resource units for the unique digital object based on the resource allocation state and the indicated quantity of resource units to transfer.

### BRIEF DESCRIPTION OF THE FIGURES

FIG. 1 illustrates a schematic representation of a system 100 in accordance with one or more embodiments of the present application;

FIG. 2 illustrates an example method 200 accordance with one or more embodiments of the present application;

FIG. 3 illustrates an example distributed computing system 300 in accordance with one or more embodiments of the present application;

FIG. 4 illustrates an example asset management procedures 400A and 400B in accordance with one or more embodiments of the present application;

FIG. 5 illustrates an example metadata transformation procedure 500 in accordance with one or more embodiments of the present application; and

FIG. 6 illustrates an example resource pool configuration 600 in accordance with one or more embodiments of the present application.

FIGS. 7-13 illustrate examples of graphical user interface view 700 in accordance with one or more embodiments of the present application.

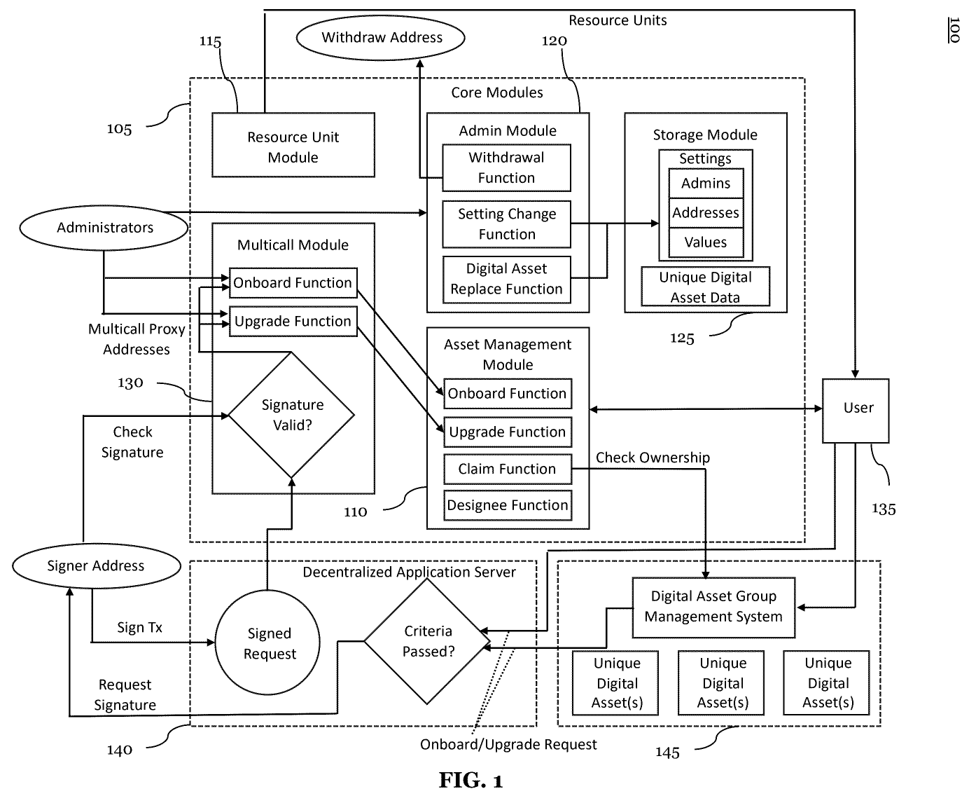

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### 1.00 System

A system 100 may be implemented as a distributed computing environment that includes on-chain executable modules (e.g., smart contracts) and off-chain interfaces that facilitate the creation, management, and utilization of unique digital objects and associated resource units. The system 100 may be deployed on a distributed ledger network and executed by a set of peer computing nodes that maintain a replicated application state and process digitally signed requests using a consensus protocol.

The system 100 may include a set of core modules 105. The set of core modules may include an asset management module 11o, a resource unit module 115, an admin module 120, a storage module 125, and a multicall module 130. Further, the system may include a user 135, a decentralized application server 140, and a digital object group management system 145.

### 1.05 Core Modules

Each module within the core modules 105 may be implemented as an executable module deployed to a distinct memory address on the distributed ledger. These modules may be stored in the form of smart contracts, where the logic and data structures associated with each module are maintained by the peer computing nodes participating in the consensus protocol. Upon deployment, the address of each module may be recorded in a registry or configuration store accessible to other modules, allowing for controlled inter-module communication and permissioned function execution.

The core modules 105 may include an asset management module 110 configured to handle asset onboarding and state transitions; a resource unit module 115 configured to manage the supply, distribution, and transfer of resource units; an admin module 120 configured to facilitate configuration changes through threshold-based authorization; a storage module 125 configured to persist allocation and asset-specific state; and a multicall module 130 configured to receive and batch instructions. These modules may be deployed independently but may be operably coupled through cross-contract calls, shared state identifiers, and/or event signaling mechanisms.

### 1.10 Asset Management Module

The asset management module 11o may be implemented as an on-chain executable module configured to coordinate lifecycle operations for unique digital objects within the system. The asset management module no may be responsible for processing signed requests submitted by external signing entities, such as user-controlled wallets or authorized agents, and may perform verifiable operations including onboarding, upgrading, claiming, and delegation. Upon deployment of a new asset, the asset management module may receive a digitally signed onboarding request that includes an identifier of the unique digital object and a memory address derived from the public key of the signing entity. In response, the module may associate the digital object with the designated address, invoke the metadata transformation interface to compute and store a virtualized computational power metric, and register the asset within the replicated application state for participation in epoch-based resource allocation.

The asset management module may also support post-onboarding operations, including upgrading the virtualized computational power metric associated with a digital object. This may be initiated via a signed request indicating an updated metric value. The module may store the updated value as a pending upgrade and activate it only after confirming that all previously allocated resource units have been claimed, ensuring fair and non-retroactive contribution to subsequent allocation cycles. For claiming resource units, the module may receive a signed request indicating the amount to be transferred, verify the asset's entitlement based on its recorded allocation state, and update the total transferred quantity accordingly. Additionally, the asset management module may support the assignment of a designee address, allowing the original asset owner to delegate transfer authority to another memory address. The module may store the designee address in the replicated application state and enforce permissions such that either the owner or the designee may execute future transfer requests.

### 1.15 Resource Unit Module

The resource unit module 115 may be implemented as an executable module deployed on the distributed ledger and configured to manage the issuance and transfer of resource units within the system. Resource units may represent digital tokens or ledger-tracked values allocated to unique digital objects based on their virtualized computational power and participation within defined epoch intervals. The resource unit module 115 may interact with the asset management module 11o during the claim process, where resource units are transferred to a memory address associated with a digital object or its designated recipient. The resource unit module 115 may validate authorized transfer requests and ensure that claimed quantities do not exceed entitlements computed by the asset management module 11o. In some examples, the resource unit module configured to manage the supply, transfer, and accounting of resource units allocated to unique digital objects. The resource unit module may be invoked by the asset management module no to mint or distribute resource units during a claim process and may be further configured to enforce transfer rules and emit events corresponding to allocation, claiming, or administrative withdrawal actions.

### 1.20 Admin Module

The admin module 120 may serve as a governance-controlled executable module configured to manage critical configuration changes and administrative operations within the system. The admin module 120 may be deployed on the distributed ledger and may maintain a list of predefined authorized computing addresses that are permitted to submit digitally signed requests proposing updates to configurable system parameters. Such parameters may include, epoch duration, resource unit allocation rates, computational power scaling thresholds, and access control designations. When a proposed change is submitted, the admin module 120 may validate the request and compare it to previously received proposals for the same parameter. Upon detecting that a defined quorum or threshold of matching requests has been reached, the module may execute the configuration change by writing the updated value to the replicated application state or signaling the relevant system module to apply the new setting.

The admin module 120 may also be configured to perform administrative withdrawal operations for resource units or other ledger-managed values accumulated within system contracts. Withdrawal requests may specify the destination address, token type, and amount, and may require approval by multiple authorized administrators before execution. Once the approval threshold is satisfied, the admin module 120 may instruct the appropriate module, such as the resource unit module 115, to perform the transfer. Withdrawal actions may be logged via on-chain events.

In some embodiments, the admin module may be further configured to receive a digitally signed asset replacement request specifying an existing unique digital object and a replacement digital object identifier. Upon verifying authorization and system state conditions, the admin module may deactivate the original asset and transfer associated state data (e.g., including the virtualized computational power metric, claim history, and designee address) to the replacement asset, thereby preserving continuity of participation while preventing double allocation. In some implementations, the admin module may emit an event recording the replacement and may update relevant indices or mappings in the storage module to ensure that future system interactions reference the valid asset identifier.

### 1.25 Storage Module

In some embodiments, the storage module 125 may be implemented as an on-chain executable module responsible for persisting key system state data related to unique digital objects, resource allocation, and epoch activity. The storage module 125 may expose controlled read and write interfaces accessible only by trusted modules, such as the asset management module 11o or admin module 120, and may enforce strict data consistency rules to ensure integrity across all time-sensitive operations. For each unique digital object, the storage module 125 may store structured records including the asset's virtualized computational power metric, onboarding block height, pending upgrade values, cumulative claimed resource units, and any designated designee address. These records may be indexed by asset identifiers and updated only in response to authenticated and authorized instructions from approved system components.

The storage module may also maintain epoch-level records, each comprising a total network computational power metric, total resource units available for the epoch, total claimed units, and derived values such as unclaimable balances. These records may enable reproducible allocation calculations and support delayed or batched claiming operations by preserving historical allocation context indefinitely. The storage module may be queried by other system modules to retrieve prior allocation states, validate claim eligibility, or resolve upgrade activation conditions.

### 1.30 Multicall Module

The multicall module 130 may be implemented as an on-chain executable module designed to optimize transaction efficiency by enabling the batch processing of multiple asset-related operations within a single blockchain transaction. This module may be used in scenarios where a large number of unique digital objects must undergo onboarding, upgrades, or claims in a coordinated or time-sensitive manner, such as at the beginning or end of an epoch. The multicall module 130 may accept a single digitally signed request that encodes a set of instructions, each including an asset identifier, an operation type, and any necessary parameters for execution. These instructions may be decoded and forwarded to the appropriate system module, such as the asset management module, for processing.

To maintain system security and integrity, the multicall module 130 may verify the digital signature of each request and ensure that the signature originates from a preauthorized signer address. This verification process may restrict multicall capabilities to trusted automation agents, administrative services, or governance-authorized controllers. Once authenticated, each instruction in the batch may be executed sequentially or conditionally, depending on system configuration. For example, the module may support atomic execution, where the entire batch succeeds or fails as a unit, or partial execution, where valid instructions are processed and failures are logged for reattempt or review.

### 1.35 User

The user 135 may be represented by a cryptographic key pair managed through a client-side wallet application, hardware device, or custodial service. The user 135 may interact with the system by submitting digitally signed requests to perform operations such as onboarding a unique digital object, upgrading its virtualized computational power metric, initiating a resource unit claim, or assigning a designee address. Each request may be signed using the user's private key and routed to the appropriate on-chain module, such as the asset management module, through direct transaction submission or via an intermediary interface, such as a decentralized application server.

The user's public key may be used to derive a blockchain-native address (i.e., a memory address) that becomes associated with the digital object for purposes of ownership, claiming, and delegation. This address may also serve as the destination for resource unit transfers initiated by the system. In some implementations, users may manage multiple digital objects, assign claiming permissions to designee addresses, and monitor allocation history through a user interface. The user's participation in the system is secured by cryptographic verification and enforced through deterministic smart contract logic, ensuring that only authorized entities may modify asset state or claim value within the distributed protocol

### 1.40 Decentralized Application Server

The decentralized application server 140 may be implemented as an off-chain computing component configured to facilitate communication between users and the on-chain modules of the system. The decentralized application server 140 may serve as a gateway for preparing and submitting digitally signed transactions, retrieving application state, and generating user-facing data representations. It may operate as an HTTP, WebSocket, or RPC-based backend service that interfaces with wallet clients, browser applications, or other distributed software agents acting on behalf of users.

The decentralized application server 140 may be responsible for formatting and transmitting signed user requests to the appropriate executable modules on the distributed ledger. For example, when a user 135 initiates an onboarding operation, the server may collect the asset's metadata, format the input payload, attach the necessary digital signature, and submit the transaction to the asset management module. Similarly, the decentralized application server 140 may handle requests to upgrade virtualized computational power metrics, assign designee addresses, or initiate resource unit claims.

In addition to transmitting transactions, the decentralized application server 140 may also support read-only state queries by invoking exposed view functions on the system's on-chain modules. These queries may include fetching an asset's current virtualized computational power metric value, participation history, claimable quantity of resource units, designee status, or epoch-based allocation records. The results may be cached, indexed, and served to front-end interfaces or third-party systems as structured JSON or other machine-readable formats

1.45 Digital object Group Management System

The digital object group management system 145 may be implemented as an on-chain or hybrid system component configured to facilitate the creation, initialization, and onboarding of new unique digital objects into the resource allocation framework. This module may manage collections of assets that are designed to participate in the system's virtualized mining and token claiming logic. Upon receiving a valid input from a user 135 or authorized agent, the digital object group management system 145 may generate a new asset instance, assign it a unique identifier, and associate it with a destination memory address derived from a provided public key.

Following generation, the digital object group management system 145 may initialize asset metadata and transmit onboarding instructions to the asset management module 110. This onboarding data may include the asset identifier, an initial virtualized computational power metric, and optional configuration parameters such as trait-based metadata or time-based eligibility markers. The asset management module 11o may then invoke the metadata transformation interface and record the asset's allocation readiness in the replicated application state, enabling the asset to begin participating in epoch-based resource distributions. The digital object group management system 145 may also maintain on-chain or off-chain registries that allow other system components or users to query information about active or inactive assets under its management. This may include mint history, initial assignment values, and status indicators reflecting whether an asset has been onboarded, upgraded, or deactivated.

2.00 Method for Epoch-Driven Resource Distribution Using Virtualized Computational Power Metrics Associated with Unique Digital Objects

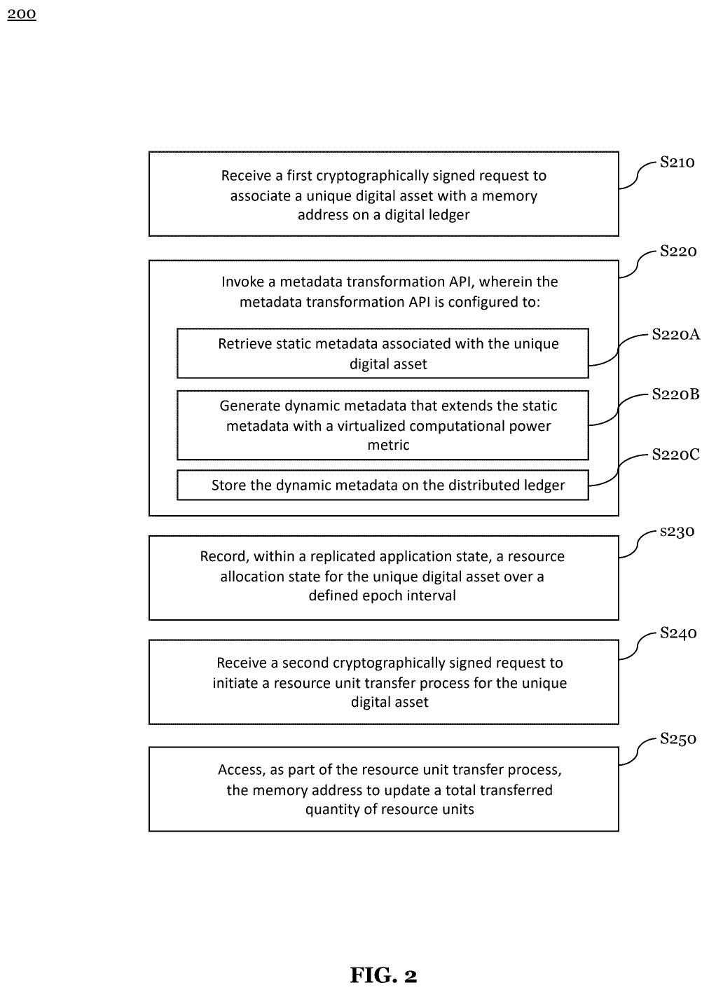

FIG. 2 may illustrate a method 200. In some embodiments, a system implementing method 200 may include a distributed ledger, which is a decentralized data structure maintained by a network of independent computing devices that collectively verify and record transactions without reliance on a central authority. This ledger may be operated by a set of peer computing nodes, where each peer node is a computing device configured to execute program instructions, participate in data validation, and store a synchronized copy of the ledger's state. These nodes may operate under a shared consensus protocol, which is a set of algorithmic rules that enables the network to agree on the validity and sequence of transactions. As a result of consensus execution, each peer node maintains a replicated application state, which is a synchronized and deterministic record of all active system data, including asset registrations, allocation metrics, and configuration parameters. This replicated state ensures that all nodes reach the same outcome for any given set of inputs, enabling secure and verifiable operation of the system across a decentralized network.

Additionally, the system implementing method 200 may include one or more computing devices implementing a metadata transformation application programming interface and operably coupled to the distributed ledger. A computing device, in this context, may refer to an off-chain server, service node, or networked computing resource capable of processing instructions and exchanging data with on-chain modules. Being operably coupled to the distributed ledger means that the device can receive data from, and submit transactions or queries to, the distributed ledger through secure, authenticated interfaces such as JSON-RPC, Web3 providers, or RESTful endpoints. The metadata transformation API may comprise a set of callable functions or endpoints that, when invoked, retrieve static metadata, such as descriptive traits or external references, associated with a unique digital object, and augment it with system-derived values to produce mutable metadata. This mutable metadata may include a virtualized computational power metric, which is a numerical representation of the asset's contribution to resource allocation logic. The API may then encode and return the transformed metadata or provide instructions for storing it on the distributed ledger in association with the corresponding digital object.

Further, the system implementing method 200 may include a deployed executable module (e.g., an asset management module) that is stored at a first memory address on the distributed ledger and executed by the peer computing nodes via the consensus protocol. The executable module may refer to a smart contract or programmatic logic unit encoded in bytecode and deployed on-chain, such that its functionality is accessible through defined function selectors or transaction calls. The first memory address refers to the unique address on the distributed ledger that identifies the location of the deployed module and allows other entities, such as users or other modules, to invoke its functions. Execution via the consensus protocol means that any operation performed by the executable module, such as processing input data or modifying the replicated application state, is validated and agreed upon by the set of peer computing nodes according to the rules of the underlying consensus mechanism. This may ensure that all state changes made by the module are deterministic, verifiable, and consistently reflected across all instances of the replicated application state. The executable module may serve as the core logic controller for asset onboarding, metadata processing, resource allocation, and token claiming within the system.

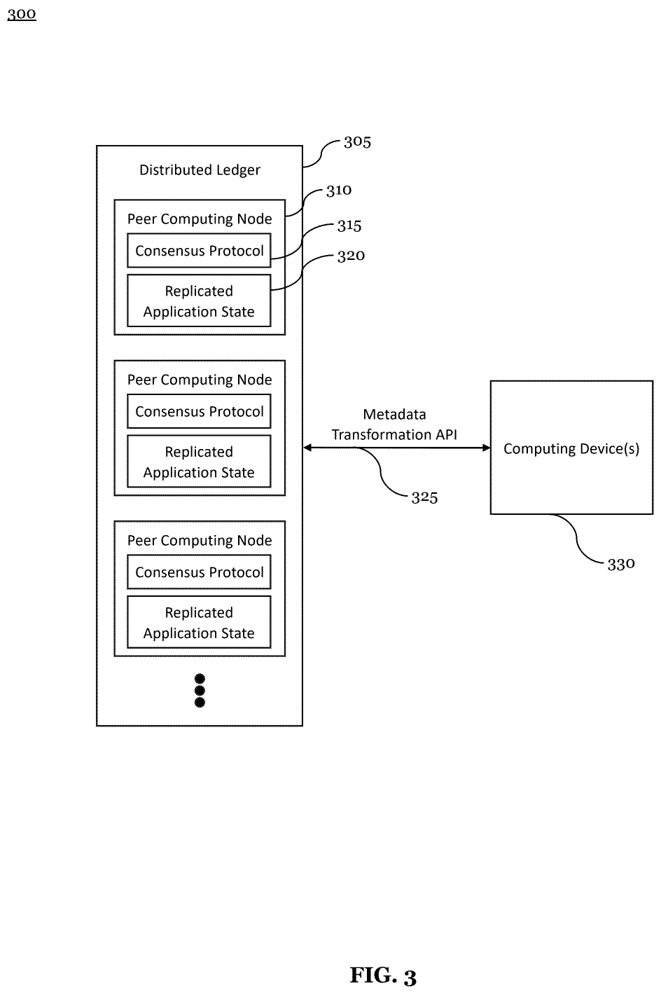

In a non-limiting example, as described with reference to FIG. 3, a distributed computing system 300 may include a distributed ledger 305 and one or more computing devices 330. The distributed ledger 305 may include a set of peer computing nodes 310 executing a consensus protocol 315 and maintaining a replicated application state 320. The one or more computing devices 330 may implement a metadata transformation API 325 and may be operably coupled to the distributed ledger 305.

As shown in FIG. 2, method 200 for implementing may include the executable module receiving a first cryptographically signed request to associate a unique digital object with a memory address on a digital ledger; invoke a metadata transformation API, wherein the metadata transformation API is configured to: retrieve static metadata associated with the unique digital object, generate mutable metadata that extends the static metadata with a virtualized computational power metric, and store the mutable metadata on the distributed ledger; record, within a replicated application state, a resource allocation state for the unique digital object over a defined epoch interval; receive a second cryptographically signed request to initiate a resource unit transfer process for the unique digital object; and access, as part of the resource unit transfer process, the memory address to update a total transferred quantity of resource units.

The techniques described herein may have one or more advantages. For instance, the system described herein may implement a virtualized computational power model that enables digital objects to participate in resource allocation without performing external computations or computing physical energy. Instead of relying on hash-based mining or continuous execution of resource-intensive tasks, the system may assign a numerical metric to each asset that represents its virtualized contribution to the network. The metric may be stored and updated on-chain and used in proportional allocation calculations based on the deterministic epoch boundaries. By replacing hardware-based consensus mechanisms with verifiable on-chain logic, the system may achieve decentralized value distribution with reduced computational overhead.

Additionally, each of the core operations of the system described herein, including onboarding, state updates, allocation calculations, and claim executions, may be processed entirely on-chain by executable modules deployed to the distributed ledger. Each operation may be initiated by a digitally signed request and validated using public key cryptography, ensuring that decision logic and state transitions are carried out within the bounds of verifiable smart contract code. This architecture minimizes reliance on off-chain services for decision-making, removes the need for centralized oracles or coordinators for core functionality, and supports end-to-end transparency and reproducibility of system behavior across all participating nodes.

Further, the system described herein may provide a modular state management architecture in which distinct types of data, such as digital object properties, allocation parameters, and epoch-level metrics, are stored in structured records within a storage module deployed on the distributed ledger. Each record may be indexed by asset identifiers or epoch markers and may be updated only through authenticated instructions issued by authorized modules. This structure may enable deterministic access to historical and current state data, may reduce the need for dynamic recomputation across distributed nodes, and may allow on-chain functions to execute efficiently using well-defined inputs. By distributing state responsibilities across specialized modules, the system may enhance scalability and maintainability in environments with high asset volumes and frequent state transitions

2.10 Receive a Request to Associate a Unique Digital Object with a Memory Address

At S210, a system implementing method 200 may be configured to receive a first digitally authenticated request from an external signing entity. The external signing entity may include a computing device, browser-based wallet, mobile application, or decentralized application (dApp) interface under the control of a user or automated agent. The signing entity may be configured to generate cryptographically signed messages using a private key corresponding to a public key, such that submitted requests can be validated by smart contracts on the distributed ledger using standard cryptographic signature verification (e.g., ECDSA on Ethereum).

The received request may include an instruction to associate a unique digital object with a second memory address on the distributed ledger. As used herein, a unique digital object may refer to an instantiation of a non-fungible identifier managed by a token contract compliant with ERC-721 or another non-fungible token standard. The asset may be represented by a token ID scoped within a specific contract address (e.g., a specific address of an executable module) and may be associated with off-chain or on-chain metadata.

The second memory address may be a blockchain-native account address derived from a public key associated with the external signing entity. For example, in Ethereum-compatible implementations, the address may be generated using a hashing function (e.g., Keccak-256) applied to the public key, yielding a 160-bit hexadecimal address. This address may serve as the storage location for resource units subsequently allocated to or claimed by the associated unique digital object.

Receiving the request may initiate an onboarding procedure in which the unique digital object is linked to the system's replicated application state. The onboarding process may prepare the asset for further participation in resource allocation processes by establishing a record of its association with the requesting entity and enabling additional functionality, such as the attachment of virtualized computational attributes or eligibility for proportional resource claims.

In some implementations, the request may also include one or more identifiers of the unique digital object (e.g., token ID and contract address), references to its static metadata location (e.g., tokenURI or IPFS hash), or initialization parameters such as an initial virtualized computational power metric. Upon receipt, the executable module deployed on the distributed ledger may verify the digital signature and update system state to reflect the association of the unique digital object with the derived second memory address.

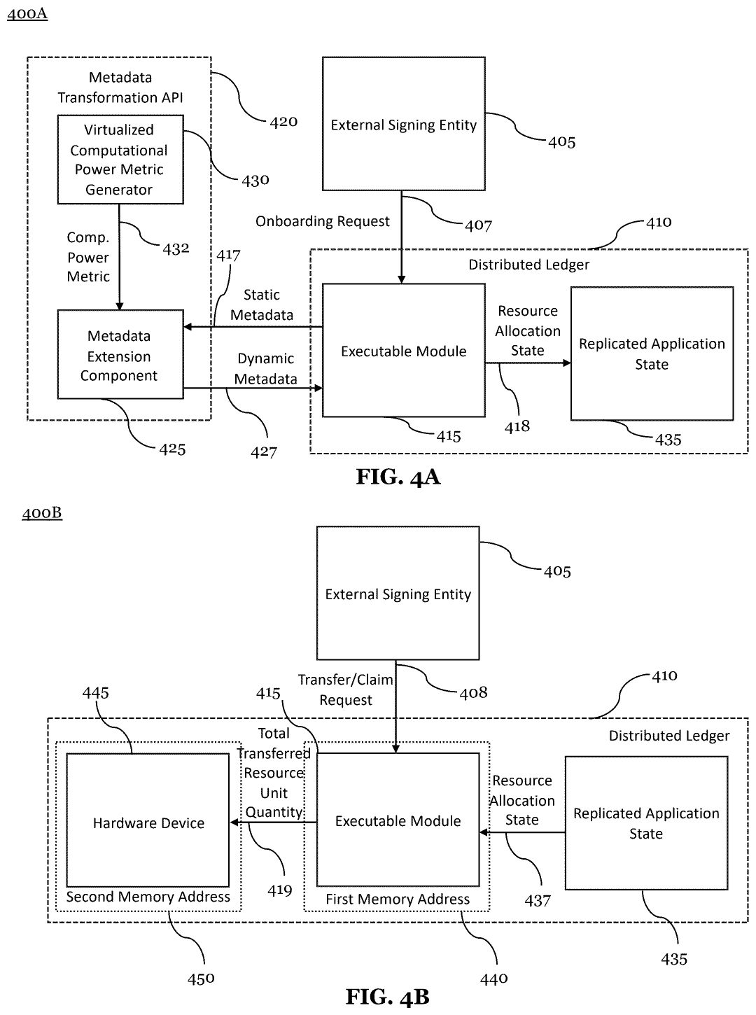

In a non-limiting example, as depicted in FIG. 4A, an external signing entity 405 may transmit an onboarding request 407 (e.g., a first cryptographically signed request). Executable module 415 of distributed ledger 410 may receive the onboarding request 407.

### 2.20 Invoke a Metadata Transformation API

At S220, upon receiving the first cryptographically signed request, the system implementing method 200 may initiate (e.g., via the executable module) an API function call to a metadata transformation application programming interface (API) that is in operable communication with the distributed ledger. The metadata transformation API may be implemented as a stateless or state-aware service that performs real-time metadata operations based on identifiers and parameters supplied in the request. The API may expose one or more callable functions that enable the retrieval, transformation, and storage of metadata corresponding to a unique digital object, where the API invocation is triggered programmatically by the executable module as part of a deterministic onboarding or update workflow.

The invocation of the API may be triggered by one or more parameters embedded in the onboarding request, such as a token identifier, a contract address, or a reference to static metadata (e.g., a tokenURI or IPFS content hash). In some configurations, the executable module deployed on the distributed ledger may act as a proxy for this invocation, forwarding the relevant asset identifiers and context to the API endpoint. In other implementations, a middleware service or distributed application (dApp) server may handle the orchestration between the ledger and the transformation logic.

Invoking the metadata transformation API may be performed to retrieve, extend, and persist enriched metadata for the unique digital object being onboarded. The transformation process may include the acquisition of static metadata (e.g., name, image, traits) and the generation of mutable metadata, including a virtualized computational power metric, a value that enables the digital object to participate in proportional resource allocation processes.

The invocation may be performed using a standardized interface such as HTTP(S), JSON-RPC, or a blockchain-native call interface, depending on the implementation. The request to the API may include the unique identifier of the digital object; a timestamp or block height for temporal consistency; and contextual values such as initialization data, metadata source references, or caller authentication credentials.

2.20A Retrieve Static Metadata Associated with the Unique Digital Object

At S220A, the system implementing method 200 may be configured to retrieve static metadata associated with the unique digital object. The static metadata may include pre-existing descriptive or structural information assigned to the asset at the time of its creation, minting, or issuance. Static metadata may include, but not be limited to, a textual or symbolic name, a description field, an image or media file references, trait-value pairs, or references to externally stored content.

The static metadata may be retrieved using one or more identifiers associated with the unique digital object, such as a token ID and a contract address. In implementations where the unique digital object conforms to a non-fungible token standard (e.g., ERC-721), the metadata transformation API may use the tokenURI function exposed by the asset's smart contract to retrieve a URI pointing to a metadata JSON object. In other implementations, the static metadata may be retrieved directly from an on-chain registry or a decentralized storage system, such as IPFS, Arweave, or Filecoin.

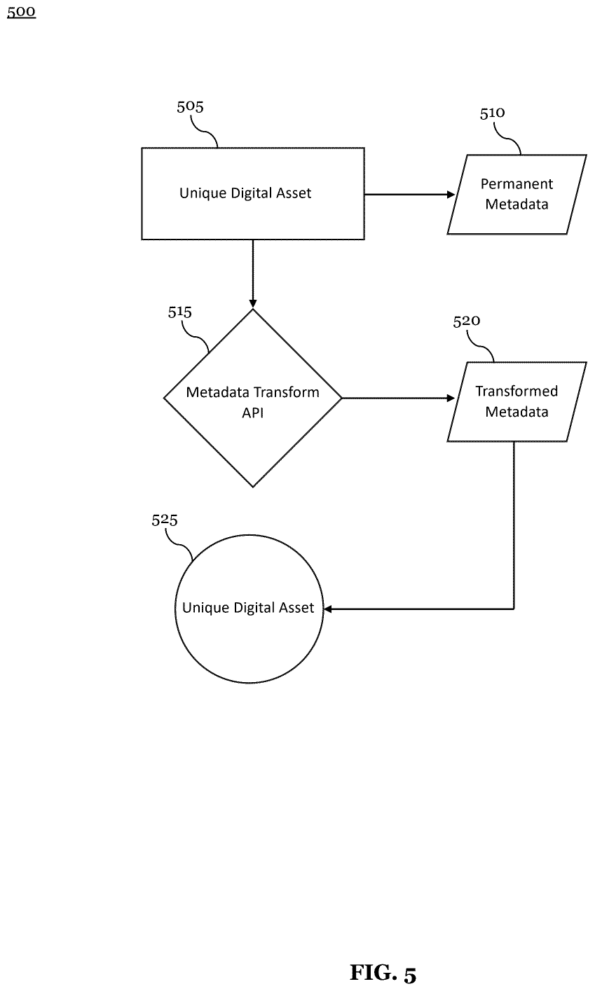

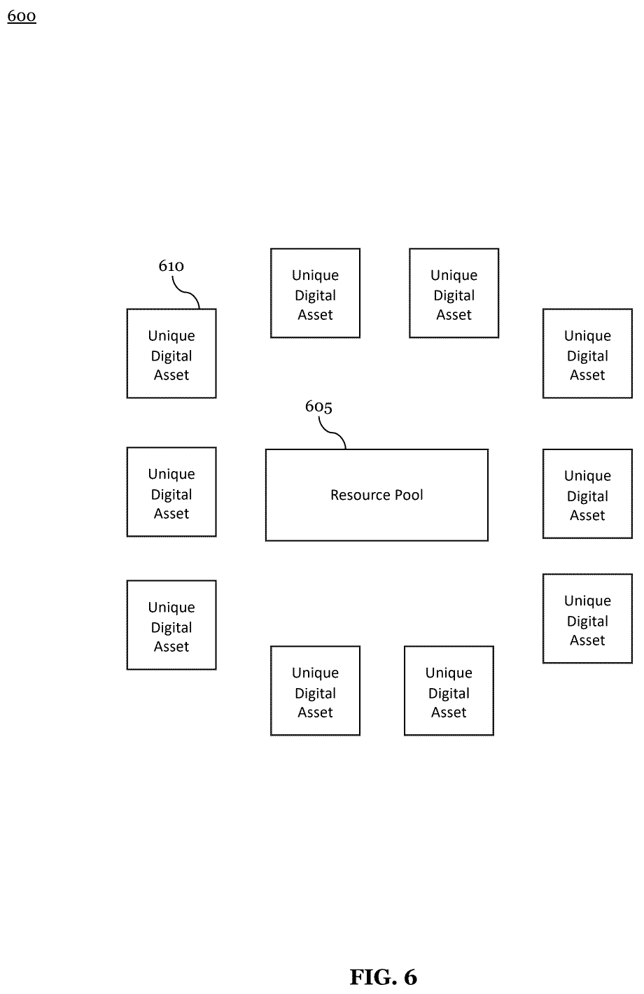

In a non-limiting example, as described with reference to FIG. 4A, executable module 415, upon receiving onboarding request 407, may transmit static metadata 417 to metadata extension component 425 via metadata transformation API 420. Alternatively, executable module 415 may transmit one or more unique digital object parameters to metadata extension component 425 that metadata extension component 425 may use to retrieve the static metadata. As depicted in FIG. 5, the static metadata of a particular unique digital object 505 may include permanent metadata 510 (e.g., immutable metadata).

2.20B Transform a Virtualized Computational Power Metric into Mutable Metadata

At S220B, the system implementing method 200 may be further configured to perform a real-time transformation of a virtualized computational power metric into mutable metadata associated with a unique digital object. As used herein, a virtualized computational power metric refers to a system-defined numeric or symbolic value assigned to a digital object that quantifies its eligibility or contribution level in the allocation of digital resources (e.g., resource units, tokens, or rewards). This metric may reflect intrinsic or derived characteristics of the digital object, such as its rarity traits, classification tier, historical participation, or prior upgrade history.

As used herein, the virtualized computational power metric may refer to a numerical value representing the relative contribution of the unique digital object to a distributed resource allocation process. In the context of the system described herein, this value may be denoted as VHASH and may serve as a proxy for computing power, eligibility weight, or claim share in a time-based resource distribution framework.

The transformation process may be initiated during the onboarding of a digital object or at specific operational checkpoints, such as upgrades or recalibration events. The metadata transformation API may retrieve the virtualized computational power metric associated with the object—either from an initial input, a trait-to-metric mapping, or a storage location within the distributed ledger—and embed or encode this value into a structured metadata format. The output of this process is referred to as mutable metadata, which denotes a set of one or more data fields associated with the digital object that may change or evolve based on system state, user input, or protocol-defined triggers.

This transformation may be performed in real time, which may refer to it occurring dynamically in response to an API function call and not relying on asynchronous or delayed processing. The transformation logic may include logic for formatting the computational power metric into a metadata schema, adding timestamp or epoch-based validity markers, and applying cryptographic encoding to ensure traceability and integrity. The transformed metadata may conform to a canonical schema recognized by other on-chain modules and off-chain services, allowing the digital object to be treated as an active system participant.

In some embodiments, transforming the virtualized computational power metric into mutable metadata for a unique digital object may include generating a structured, machine-readable metadata file that encodes one or more system-derived properties, including the computational power metric itself. The structured metadata file may be formatted in a data structure such as JSON, CBOR, or a protocol-specific ABI-encoded format. This file may include additional metadata attributes such as epoch registration, resource allocation parameters, or status flags indicating whether the digital object has been designated as an operating digital object.

The generated metadata file may be stored at a memory address distinct from the memory address associated with the unique digital object. As used herein, a memory address refers to a unique storage location on the distributed ledger, such as a smart contract storage slot, content hash-based address (e.g., IPFS or Arweave URI), or contract-bound reference field. Additionally, to maintain a verifiable and retrievable association between the unique digital object and its corresponding metadata, the executable module may record, within the replicated application state, a linkage record that maps the memory address of the digital object to the memory address of the structured metadata file. This linkage may be recorded using a registry mapping, pointer structure, or hash-indexed reference.

In a non-limiting example, as described with reference to FIG. 4A, virtualized computational power metric generator 430 may generate a virtualized computational power metric 432 and may provide virtualized computational power metric 432 to metadata extension component 425. Metadata extension component 425 may extend the static metadata 417 with the virtualized computational power metric 432 to generate mutable metadata 427 and may provide mutable metadata to executable module 415. It should be noted that there may be examples where the virtualized computational power metric 432 is provided by executable module 415 (e.g., included as part of the parameters of the onboarding request 407).

In another non-limiting example, as depicted in FIG. 5, a unique digital object 505 may be provided to metadata transform API 515 and metadata transform API may output a unique digital object 525 with transformed metadata 520. This transformed metadata 520 may, for instance, be mutable. In some examples, the transformed metadata may include the virtualized computational power metric.

### 2.20C Store the Mutable Metadata

At S220C, the system implementing method 200 may be configured to store the resulting metadata on the distributed ledger in association with the corresponding unique digital object. The storage operation may include writing the metadata to a designated on-chain memory location that is logically or cryptographically linked to the object's identity, such as its unique identifier or associated blockchain address.

The mutable metadata stored on the ledger may include, at a minimum, the virtualized computational power metric and any supporting metadata fields derived or calculated during the transformation process. These may include data such as the asset's operating status, epoch of activation, upgrade history, or resource unit claim statistics. The metadata may be serialized in a format compatible with system modules, such as a structured key-value map or a protocol-defined encoding scheme (e.g., JSON, CBOR, or ABI-encoded struct).

Once stored, the system may designate the digital object as an operating unique digital object, signifying that it has met the criteria to begin participating in system processes that involve the accrual and extraction of digital resources. As used herein, an operating unique digital object refers to any digital object that has undergone onboarding and metadata transformation and has been assigned an active computational power metric recognized by the system for resource allocation purposes. The designation may be recorded implicitly through the presence of transformed metadata or explicitly via a status flag or registry entry maintained in the replicated application state,

Following this designation, the operating unique digital object may become eligible to extract digital resources-such as resource units-based on its assigned virtualized computational power metric. This eligibility may be determined by system modules using proportional allocation algorithms during defined epoch intervals. The system may access the stored metadata to calculate the object's share of total distributable resources and verify that claims or transfer requests conform to its recorded allocation capacity.

2.30 Record a Resource Allocation State within a Replicated Application State

At S230, the system implementing method 200 may be configured to record a resource allocation state for the unique digital object within the replicated application state maintained by the peer computing nodes. This state may represent the asset's eligibility to receive a quantity of resource units (e.g., VTOKEN) over a defined epoch interval, based on its virtualized computational power metric relative to other assets in the system. As used herein, an epoch interval may refer to a predefined span of blockchain blocks, timestamps, or other verifiable temporal markers. In Ethereum-based implementations, an epoch may be defined as a fixed number of blocks (e.g., 216,904 blocks≈˜1 month), allowing for deterministic and decentralized synchronization of allocation cycles.

The resource allocation state for each asset may include a computed allocation value, which may be determined using a proportional formula such as

$$\frac{V H A S {H}_{asset}}{V H A S {H}_{epoch}} * Epoch\_Supply ,$$

where VHASHₐₛₛₑₜ may refer to the virtualized computational power of the unique digital object, VHASH_{epoch} may refer to an aggregate of all virtualized computational power metric values recorded for an epoch and Epoch_Supply may refer to a fixed or configurable amount of resource units allocated for the epoch.

The executable module may compute and persist this allocation value in the replicated application state using an indexed structure that associates the unique digital object (e.g., via its token identifier) with the epoch identifier, the calculated allocation amount, and/or status indicators (e.g., whether it is claimed/unclaimed, designee access, or time-to-expiry).

In a non-limiting example, as described with reference to FIG. 4A, executable module 415 may record resource allocation state 418 at replicated application state 435.

### 2.40 Receive a Request to Initiate a Resource Unit Transfer Process

At S240, the system implementing method 200 may be configured to receive a second cryptographically signed request from the external signing entity associated with the unique digital object, the purpose of which may be to initiate a resource unit transfer process. The signing entity may include a software client, hardware wallet, smart contract agent, or distributed application interface capable of generating digitally signed messages using a private key corresponding to a blockchain-recognized public key.

This second request may indicate an intent to claim or withdraw a quantity of resource units that have been previously allocated to the unique digital object in accordance with the resource allocation state recorded in step S26o. The request may include an identifier of the digital object (e.g., token ID and contract address), a digital signature generated using the external signing entity's private key, and/or an indication of the desired quantity of resource units to transfer.

In some configurations, the system may be designed to accept partial claims, allowing the external signing entity to withdraw a portion of the accumulated allocation. In other implementations, the system may require the entire unclaimed balance for an epoch to be transferred in a single operation. The digitally signed request may be transmitted via a transaction submitted to the distributed ledger and routed to the executable module responsible for managing resource transfers. Upon receipt, the module may perform a verification process to authenticate the request, which may include validating the digital signature against the known public key associated with the second memory address, validating the digital signature against the known public key associated with the second memory address and ensuring that the indicated quantity of resource units is less than or equal to the unclaimed allocation recorded in the replicated application state.

In a non-limiting example, as described with reference to FIG. 4A, external signing entity 405 may provide a transfer request 408 (e.g., a claim request, a second cryptographically signed request) to executable module 415.

### 2.50 Access a Memory Address to Update a Total Transferred Quantity of Resource Units

At S250, the system implementing method 200 may initiate a resource unit transfer operation, which may include accessing a second memory address to update the total transferred quantity of resource units associated with the unique digital object. The second memory address may be a blockchain-native account address, derived from a public key associated with the external signing entity, and may serve as the designated recipient address for resource units claimed or allocated to the asset. The resource unit transfer process may include one or more of retrieving the current unclaimed allocation for the asset from the replicated application state, determining whether the indicated quantity is within the permissible claim limit for the relevant epoch or time window, and calculating an updated cumulative total based on previously transferred amounts and the current transfer quantity.

The executable module may write an updated value for the total transferred quantity to the replicated application state. In some implementations, the system may emit an event log indicating the completion of the transfer, including metadata such as an asset identifier, a quantity transferred, a block number of the transaction, and the destination address (e.g., the second memory address). The transfer of resource units may be performed directly from a smart contract holding the supply of resource units (e.g., the resource unit module). In some embodiments, the second memory address may be replaced or overridden by a designee address authorized by the asset owner. In such cases, the updated total transferred quantity may be recorded with reference to the unique digital object.

In a non-limiting example, as described with reference to FIG. 4A, external signing entity 405 may retrieve, from replicated application state 435, resource allocation state 437 (e.g., a copy of resource allocation state 418). From resource allocation state 437, executable module 415 may determine a virtualized computational power. Using parameters of the transfer request, the executable module 415 may determine a total transferred resource unit quantity 419 and may access the second memory address 450 of a hardware device 445 to update the total transferred unit quantity at hardware device 445. Executable module 440 may be located at a first memory address 440 on the digital ledger 410.

### Updating the Virtualized Computational Power Metric

In some embodiments, the system may support dynamic modification of a virtualized computational power metric associated with a unique digital object. This modification may be initiated when the executable module receives a third cryptographically signed request from the external signing entity, the request comprising an updated value of the virtualized computational power metric. The updated value may reflect an increase in computational power entitlement, which may be acquired through system-defined upgrade mechanisms, user input, or authorized administrative functions. The executable module may validate the request and, upon verification, initiate the process of modifying the computational power metric associated with the digital object.

To preserve temporal fairness and prevent retroactive enhancement of allocation rights, the system may implement a pending value mechanism. Rather than immediately applying the updated value, the executable module may store it in a designated data field within the replicated application state as a pending computational power value. This pending value may remain inactive and excluded from resource allocation calculations until a set of preconditions is satisfied. Specifically, the system may be configured to verify that all resource units allocated to the unique digital object during one or more preceding epoch intervals have been claimed or transferred. This verification may be based on claim history records and allocation logs stored in the replicated application state, allowing the system to confirm that the digital object's entitlements from previous epochs have been fully realized.

Upon successful verification, the system may merge the pending value with the active computational power metric and use the updated metric to compute a second resource allocation state during the next eligible epoch. This allocation state may be based on the proportion of the updated metric relative to the total computational power metric of all participating digital objects during that second epoch.

### Delegated Transfer via Designee Address

In some embodiments, the system may enable the assignment of a designee address for a unique digital object, allowing an entity other than the original signing entity to initiate resource unit transfer operations. The executable module may receive a third cryptographically signed request from the external signing entity, the request including an instruction to designate a secondary memory address as the designee for the unique digital object. This secondary memory address may be derived from a public key associated with the designee and may serve as an authorized proxy for executing future claim or transfer operations. Upon receipt and verification of the request, the executable module may store the designee address within the replicated application state in association with the corresponding unique digital object.

Once the designee address has been recorded, the system may be further configured to receive a fourth cryptographically signed request, originating from either the external signing entity or the designee address, indicating a second quantity of resource units to transfer. This fourth request may follow the same validation flow as other transfer operations, including signature verification, authorization checks, and retrieval of the current allocation or claimable balance. In response to the request, the executable module may access the designee memory address and initiate a transfer of resource units in accordance with the indicated quantity, updating the total transferred quantity associated with the unique digital object accordingly.

### Recording Resource Allocation Inputs in Epoch-Based State Structures

In some embodiments, the system may be configured to record, within the replicated application state, the component values used to calculate a resource allocation state for each unique digital object participating in a defined epoch. Specifically, the executable module may store, for each epoch interval, (i) the total computational power metric of all participating assets, (ii) the virtualized computational power metric of the individual digital object, and (iii) the total quantity of resource units available for allocation in the epoch. These values may be written as part of a structured data record associated with a unique epoch identifier and indexed per asset.

The total computational power metric may represent the aggregated virtualized computational power contributed by all eligible digital objects for a particular epoch. This value may be finalized at a specific block height marking the start or end of the epoch, and it may be used as the denominator in proportional allocation calculations. The virtualized computational power metric for the individual asset may reflect either the value assigned during onboarding or an upgraded value that has been activated prior to or during the epoch, subject to eligibility and prior claim conditions. The total quantity of resource units available for allocation may be a fixed or configurable parameter defined by system governance and may be shared proportionally among all active assets based on their relative computational contributions.

Storing these inputs in the replicated application state may enable the system to compute the allocation value deterministically using on-chain data alone. This design eliminates the need for recomputation of global state at the time of claiming and supports deferred or batched claims, in which assets may claim resource units from prior epochs at a later time without introducing inconsistencies. In some implementations, these values may also be used to enforce claim limits, prevent over-allocation, and enable smart contracts to validate that a transfer request does not exceed the asset's proportional entitlement.

In some embodiments, the executable module may be configured to retrieve a previously recorded resource allocation state in response to receiving a cryptographically signed request to transfer resource units associated with a unique digital object. The system may access the stored values corresponding to the relevant epoch, including the total computational power metric, the asset-specific virtualized computational power metric, and the total quantity of resource units available for allocation. Based on these inputs, the executable module may compute a proportional allocation for the asset and determine the maximum quantity of resource units that may be transferred. This value may be compared against the quantity specified in the request, and a validated amount may be transferred accordingly. The system may then update the replicated application state to reflect the portion of the allocation that has been claimed, thereby enabling partial transfers and preventing duplicate or excessive claims.

In cases where a digital object is onboarded after the beginning of an epoch, the system may also incorporate a participation adjustment into the allocation calculation. The executable module may determine a participation duration by computing the number of blocks that the asset was active during the epoch, relative to the total number of blocks defining the epoch interval. This ratio may be used to scale down the asset's allocation proportionally, ensuring that the quantity of resource units available for transfer reflects the asset's actual contribution period.

Additionally, the system may account for cases in which the aggregate resource unit entitlements across all participating digital objects do not exhaust the total quantity of resource units available for the epoch. After computing the respective allocation for each participating asset, factoring in both the computational power metric and any participation duration adjustment, the executable module may sum these values to determine an aggregate claimed or claimable amount. If this total is less than the full quantity allocated for the epoch, the difference may be identified as unclaimable. The unclaimable amount may be recorded in the replicated application state, supporting downstream use cases such as token burning, reserve redistribution, or epoch-based carryover, depending on the system's configuration and governance parameters.

### Delegated State Management Via a Storage Module

In some embodiments, the system may incorporate a storage module deployed on the distributed ledger to manage persistent data storage and state retrieval for digital objects and epochs. This storage module may serve as a dedicated state management contract, enabling the executable module described previously to offload read and write operations related to resource allocation, computational power metrics, and claim history. As part of this configuration, recording the resource allocation state for a unique digital object may include transmitting the allocation data to the storage module, which stores the data in a structure indexed by the asset identifier and associated epoch.

The executable module may also be configured to retrieve state data from the storage module during execution of key operations, such as processing resource unit transfers. For example, when a claim request is received, the system may access the storage module to retrieve the stored values representing the asset's computational power metric, the total network power for the relevant epoch, and the asset's prior claim history. This retrieved data may then be used to validate the claim, calculate the permissible transfer amount, and update the claimable or claimed balance accordingly. Because the storage module may be restricted to accept updates only from trusted modules (e.g., the executable module), it ensures integrity of the ledger-backed application state while supporting secure inter-contract coordination.

In some configurations, the storage module may store a data record for each unique digital object, including attributes such as onboarding time, current and pending computational power metrics, designee addresses, and cumulative claimed quantities. It may also maintain per-epoch records containing global parameters such as total VHASH, total tokens allocated, and total tokens claimed for each epoch interval. The storage module may expose read-only interfaces for retrieving this data and write interfaces that accept authorized state update instructions from the executable module. This architecture promotes system modularity, improves traceability, and ensures that application state can be reconstructed or audited using structured on-chain records.

### Governance and Configuration Management Via an Admin Module

In some embodiments, the system may include an admin module deployed on the distributed ledger, configured to manage system-wide configuration settings and enforce governance controls through a threshold-based update mechanism. The admin module may be responsible for receiving and storing digitally signed configuration update requests submitted by one or more predefined authorized computing addresses. Each request may specify a proposed modification to a configuration parameter, such as epoch duration and allocation limits, and may include a digital signature that can be verified against a known set of administrator public keys stored on-chain.

The admin module may be configured to compare incoming configuration requests to determine whether a quorum or threshold of matching proposals has been reached for a particular parameter. This may involve counting identical proposals submitted by different authorized addresses within a defined time window or block range. Once the threshold condition is satisfied, the admin module may issue an update instruction that modifies the corresponding parameter value stored in the replicated application state. The updated value may then be referenced by other components of the system, such as the executable module or storage module, during operations such as onboarding, allocation, or transfer validation.

### Batch Instruction Execution Via a Multicall Module

In some embodiments, the system may include a multicall module deployed on the distributed ledger, configured to optimize transaction throughput and reduce gas costs by enabling the batch submission and execution of multiple asset-related operations. The multicall module may be designed to receive a single cryptographically signed request that includes a batch of encoded instructions, each corresponding to an operation involving a distinct unique digital object. Each instruction within the batch may include data such as the asset identifier, an operation type (e.g., onboarding, upgrading, or claiming), and any associated parameters required for execution by the system's primary executable module.

To ensure that the batch request is authorized, the multicall module may be configured to verify the cryptographic signature of the request against a predefined signer address or allowlist. This verification step may ensure that only designated automation systems, backend services, or trusted agents are permitted to submit batch instructions. Once verified, the multicall module may decode the batch payload and forward each individual instruction to the appropriate interface of the executable module for processing. The forwarded instructions may be executed sequentially or in a fail-safe manner depending on system policy, enabling partial success or full transaction reversion if an error is encountered. The multicall module enhances the operational efficiency of the system by reducing the number of separate transactions required for managing multiple digital objects.

The multicall module may enable the aggregation and sequential execution of multiple instructions within a single transaction submitted to the blockchain. This design may reduce the overhead associated with submitting and processing separate transactions for each asset, may improve throughput across peer computing nodes, and may enable protocol-level synchronization of multiple actions in a single block interval

### Off-Chain Coordination and Interface Support Via a Decentralized Application Server

In some embodiments, the system may further comprise a distributed application server operably coupled to the distributed ledger and configured to serve as a coordination layer between external users and the on-chain executable module. The application server may be implemented as one or more computing devices capable of receiving digitally signed input data from external client devices, such as web browsers, mobile applications, or automated agents. The input data may include onboarding requests, computational power upgrade instructions, designee assignments, or resource unit transfer operations, each of which may be prepared for submission as one or more transactions to the distributed ledger.

The application server may be further configured to construct and transmit these transactions in the form of properly formatted payloads, adhering to the communication and encoding standards required by the blockchain network. This may include serializing transaction data using ABI (Application Binary Interface) encoding, assigning gas limits and nonces, and submitting the transaction payloads for execution by the peer computing nodes on the network. In addition to write operations, the application server may also issue read-only function calls to the executable module, retrieving state variables such as a digital object's virtualized computational power metric, epoch participation data, and unclaimed token balances.

Based on the retrieved application state data, the distributed application server may be further configured to generate structured output, which may include JSON-formatted metadata or API responses consumed by other software components. This output may be used to render the current status of a digital object, display pending or historical claims, and present contextual indicators, such as whether an upgrade is active or a claim is available.

### Automated Asset Generation and Registration Via a Digital Object Group Management System

In some embodiments, the system may include a digital object group management system deployed on the distributed ledger and configured to generate and initialize unique digital objects for use within the broader resource allocation framework. This module may be responsible for minting new digital objects, each associated with a unique identifier, and assigning them to a target address specified in the onboarding input. The onboarding input may be provided by an external signing entity, such as a wallet or automation tool, and may include configuration parameters such as the desired initial virtualized computational power metric or optional metadata tags.

Once a new digital object is generated, the digital object group management system may transmit a data payload to the executable module to complete the onboarding process. This payload may include the asset's identifier and the assigned initial value of the virtualized computational power metric. In response, the executable module may invoke the metadata transformation API (if applicable), record the asset's resource allocation eligibility, and link the asset to a memory address associated with the originator or a designee. The system may also store this information within the replicated application state to enable future transfer, upgrade, and claim operations based on the initialized parameters.

The digital object group management system may further support persistent tracking of the asset's initialized state and provide a read-accessible metadata interface. In some configurations, the system may respond to metadata queries by generating encoded asset profiles that include both static and system-derived attributes, such as the asset's initial virtualized computational power metric value, assigned address, and epoch of origin.

### Consensus Node Selection Based on Virtualized Computational Power

In some embodiments, the consensus protocol executed by the peer computing nodes may incorporate a selection mechanism based at least in part on the virtualized computational power metrics associated with one or more unique digital objects registered within the system. Each peer computing node may be associated with, or designated to act on behalf of, one or more digital objects. The system may evaluate the relative computational power of these assets, such as their VHASH values stored in the replicated application state, to determine a weighted probability that a given node will be selected to propose or validate the next block on the distributed ledger.

The executable module may be configured to perform this evaluation by aggregating the virtualized computational power metrics for all active digital objects and calculating, for each node, a weighted selection score based on the proportion of associated power metrics under its control. This score may then be used to generate a selection signal that informs the consensus protocol of which peer node is eligible to initiate block generation.

### Interactive Graphical User Interfaces

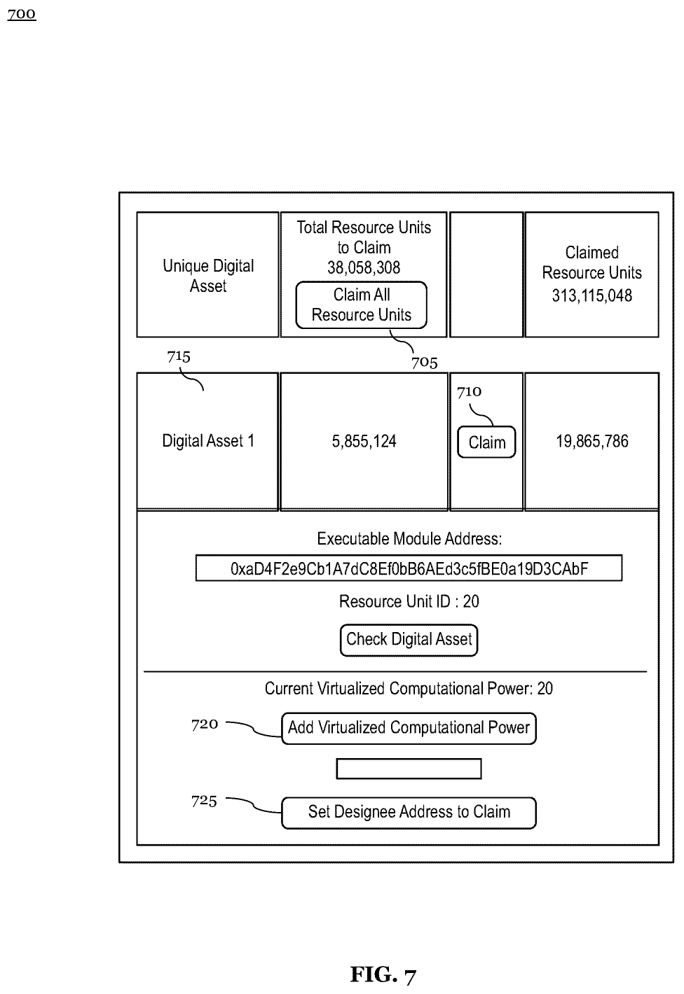

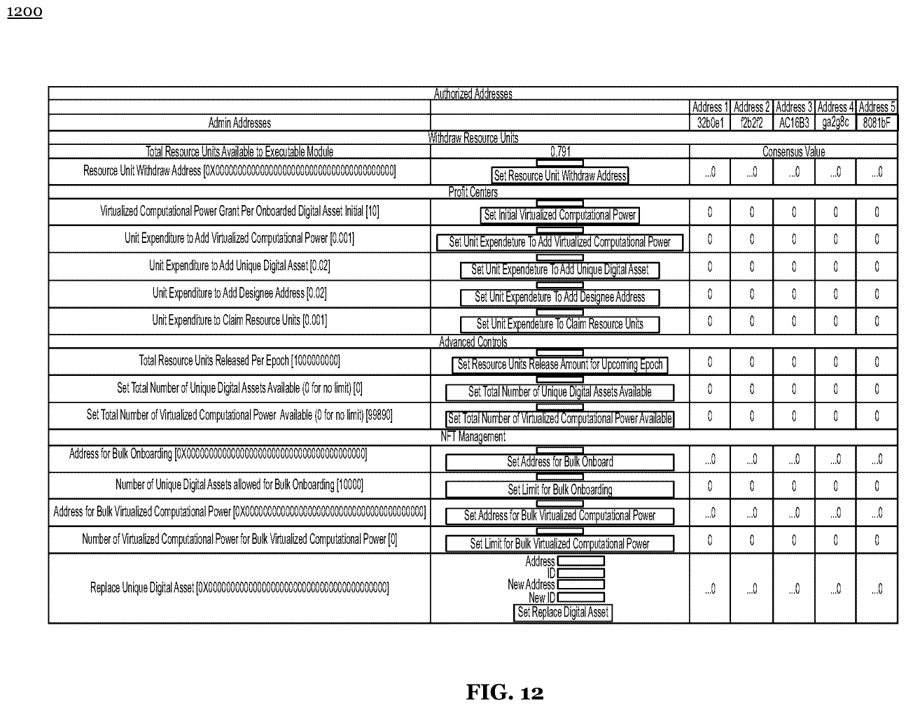

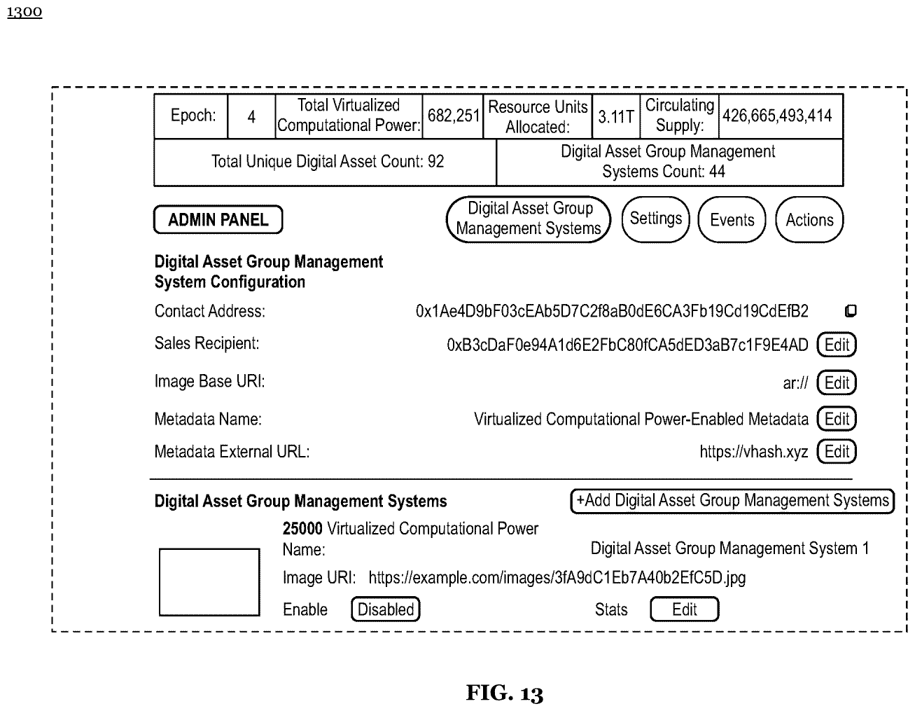

The techniques described herein may be enabled via interaction with a user interface, such as an interactive graphical user interface. FIGS. 7 through 11 may depict various views of such a graphical user interface that enable a user to interact with an asset management module as described herein. FIGS. 12 and 13 may depict various views of a graphical user interface that enable an administrator to interact with an admin module as described herein.

FIG. 7 may depict a first graphical user interface view 700 for interacting with an asset management module. The first graphical user interface view 700 may include user interface control elements associated with functions of the asset management module. For instance, when user input is provided to user interface control element 705, a transfer/claim request signal may be provided to the asset management module in order to claim resource units associated with all digital objects linked to a particular user (e.g., digital object 715 and any others). Alternatively, when user input is provided to user interface control element 710, a transfer/claim request signal may be provided to the asset module in order to claim resource units associated with just one digital object (e.g., digital object 715). Additionally, when user input is provided to user interface control element 720, an update signal may be provided to the asset management module to update a virtualized computational power metric according to a user requested value (e.g., a value input into a user interface input element). Further, when user input is provided to user interface control element 725, a designee signal may be provided to the asset management module to set a designee address to claim resource units. The graphical user interface view for FIG. 7 may further include user interface display elements indicating a total number of resource units to claim (e.g., associated with all unique digital objects for a user or a particular unique digital object such as digital object 715), a total number of claimed resource units (e.g., associated with all unique digital objects for a user or a particular unique digital object such as digital object 715), an executable module address, a resource unit ID (e.g., a token ID), and/or a current virtualized computational power metric value.

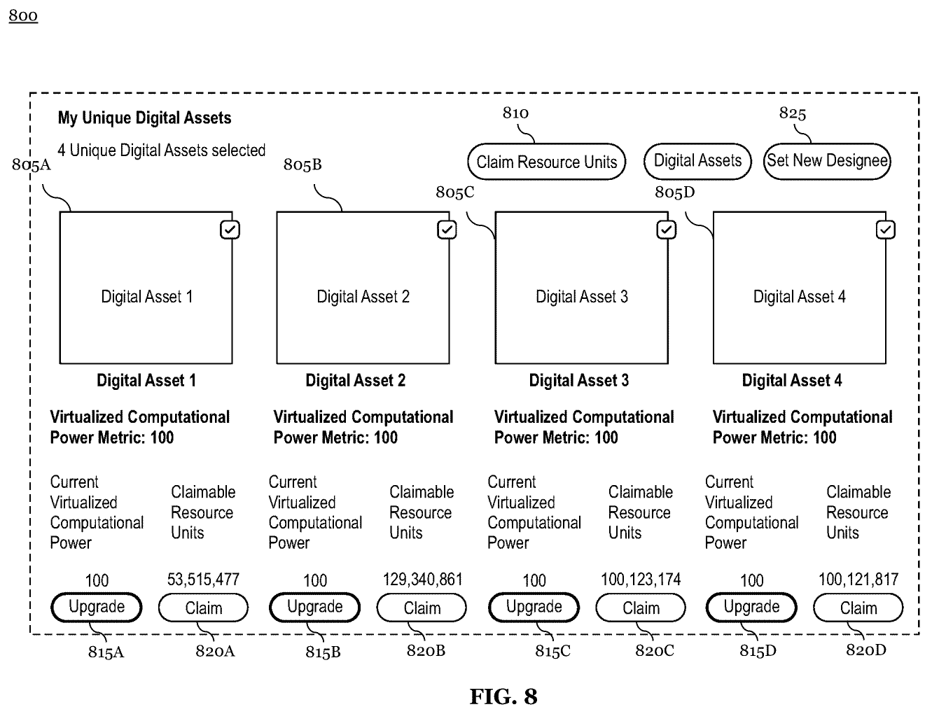

FIG. 8 may depict a second graphical user interface view 800 for interacting with an asset management module. The second graphical user interface view 800 may include user interface control elements associated with functions of the asset management module. For instance, when user input is provided to user interface control element 81o, a transfer/claim request signal may be provided to the asset management module in order to claim resource units associated with all digital objects linked to a particular user (e.g., each of digital objects 805A, 805B, 805C, and 805D) or those specifically selected within a subset of the total number of digital objects linked to a particular user. Alternatively, when user input is provided to one of user interface control elements 820A, 820B, 820C, and 820D, a transfer/claim request signal may be provided to the asset module in order to claim resource units associated with just digital object 805A, 805B, 805C, or 805D, respectively. Additionally, when user input is provided to user interface control element 820A, 820B, 820C, or 820D, an update signal may be provided to the asset management module to update a virtualized computational power metric for digital object 805A, 805B, 805C, or 805D, respectively, according to a user requested value. Further, when user input is provided to user interface control element 825, a designee signal may be provided to the asset management module to set a designee address to claim resource units. The graphical user interface view for FIG. 8 may further include user interface display elements indicating a current virtualized computational power metric value and a total quantity of claimable resource units for each of digital objects 805A, 805B, 805C, and 805D, respectively.

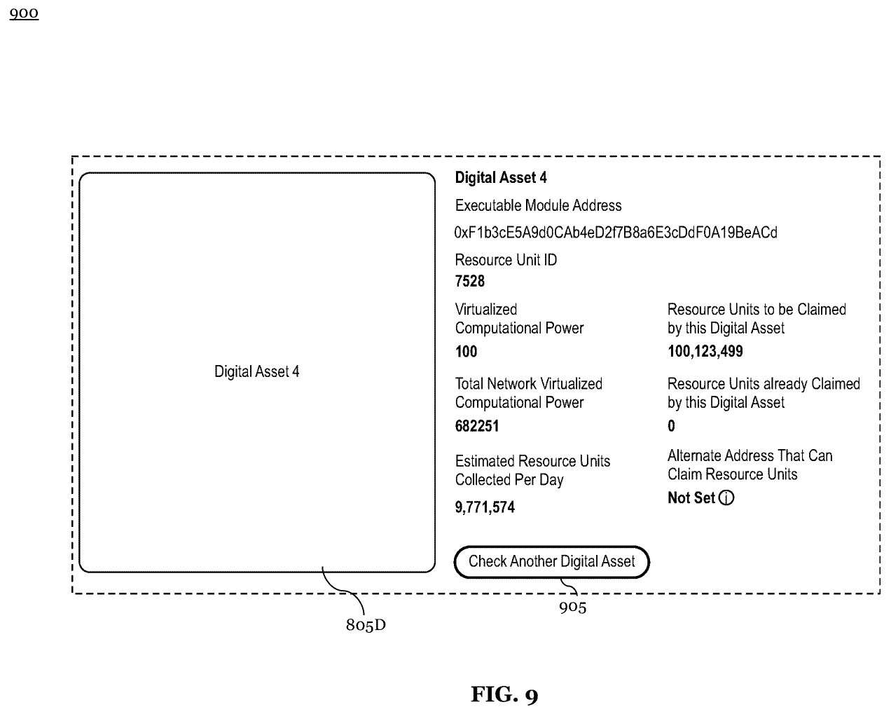

FIG. 9 may depict a third graphical user interface view 900 associated with one of the digital objects of FIG. 8 (e.g., digital object 905) that provides more information on the digital object. For instance, the graphical user interface view 900 may depict, for digital object 805D, a corresponding executable module address (e.g., a corresponding smart contract address), a resource unit ID (e.g., a. token ID), a total network virtualized computational power metric value, a system-derived allocation projection per defined time interval for digital object 805D, a total quantity of resource units claimable by digital object 805D, a quantity of resource units already claimed for digital object 805D, and a designee address (if set).

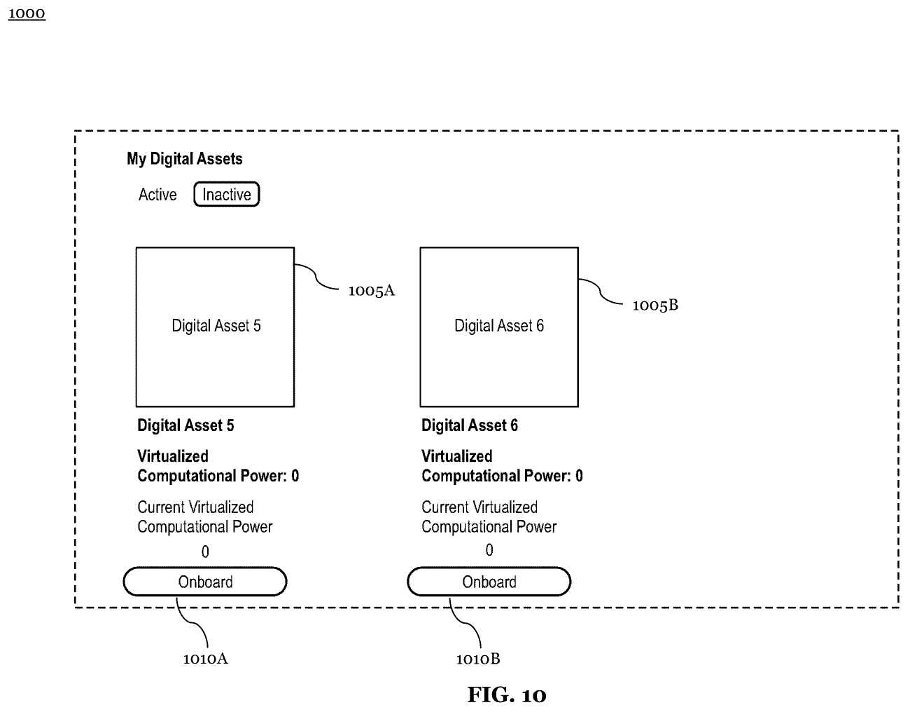

FIG. 10 may depict a fourth graphical user interface view 1000 for interacting with an asset management module. Graphical user interface view 800 may depict unique digital objects that are active (e.g., have a current non-zero virtualized computational power metric value), whereas graphical user interface view 1000 may depict unique digital objects that are inactive (e.g., have a current zero or null virtualized computational power metric value). The fourth graphical user interface view 1000 may include user interface control elements associated with functions of the asset management module. For instance, when user input is provided to user interface control elements 1010A or 1010B, an onboarding request signal may be provided to the asset management module in order to onboard unique digital objects 1005A or 1005B, respectively.

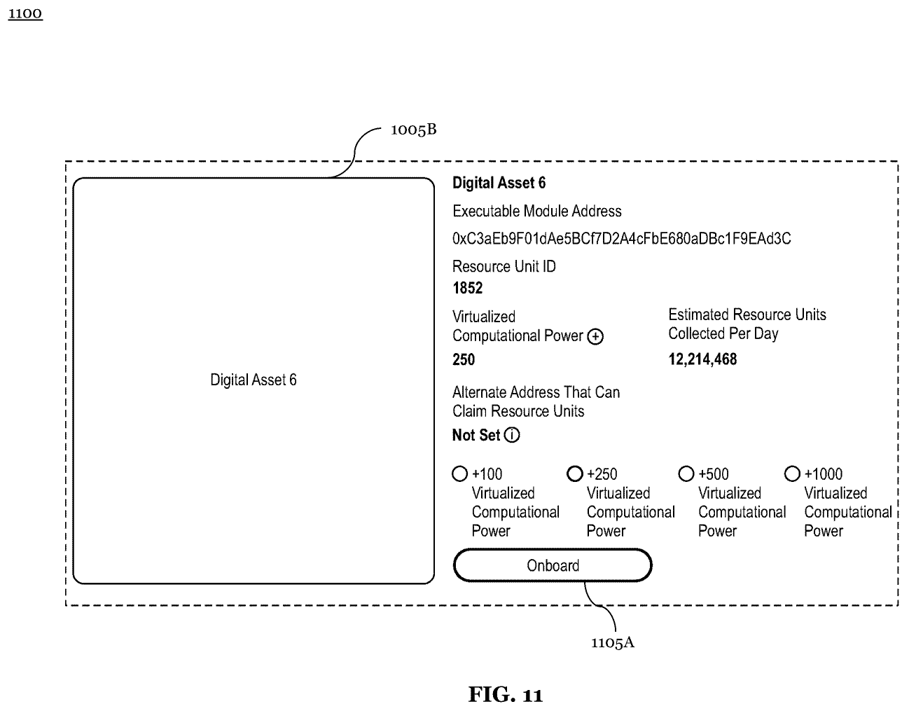

FIG. 11 may depict a fifth graphical user interface view 1100 associated with one of the digital objects of FIG. 10 (e.g., digital object 1005B) that provides more information on the digital object. For instance, the graphical user interface view 900 may depict, for digital object 1005B, a corresponding executable module address (e.g., a corresponding smart contract address), a resource unit ID (e.g., a. token ID), a user-selectable value of a virtualized computational power, a system-derived allocation projection per defined time interval using the virtualized computational power, and a designee address. Further, the graphical user interface view 900 may include user interface input elements that enable a user to select an initial virtualized computational power metric value for digital object 1005B and may include a user interface control element 1105A that, when provided user input, triggers generation of a corresponding onboarding request signal for digital object 1005B.

FIGS. 12 and 13 may depict various graphical user interface views 1200 and 1300 for interacting with an admin module. FIG. 12 may depict various parameters that may be set via a respective user interface input element and a respective user interface control element. For instance, as depicted in FIG. 12, a resource unit withdrawal address, an initial virtualized computational power grant per onboarded digital object value, a unit expenditure to add virtualized computational power, a unit expenditure to add a unique digital object, a unit expenditure to claim resource units, a total quantity of resource units released per epoch, a total number of unique digital objects available, a total number of virtualized computational power available, an address for bulk onboarding, a number of unique digital objects allowed bulk onboarding, an address for bulk virtualized computational power, a number of virtualized computational power for bulk virtualized computational power, or a replacement unique digital object for a current unique digital object may be set via administrator input. FIG. 13 may depict an additional or alternative admin graphical user interface view 1300. The graphical user interface view 1300 may display information on a current epoch, a total virtualized computational power, a total quantity of resource units allocated, a circulating supply of resource units, a total quantity of unique digital objects, and a total quantity of digital object group management systems (or of unique digital objects managed by a digital object group management system). Further, graphical user interface view 1300 may depict digital object group management system configuration information and may further include information on currently existing digital object group management systems.

### 3. Computer-Implemented Method and Computer Program Product

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

What is claimed is:

1. A distributed computing system, comprising:
a distributed ledger comprising a plurality of peer computing nodes executing a consensus protocol and maintaining a replicated application state;
one or more computing devices implementing a metadata transformation application programming interface (API) that is in operable communication with the distributed ledger; and
a deployed executable module stored at a first memory address on the distributed ledger and executed by the plurality of peer computing nodes via the consensus protocol, the deployed executable module comprising instructions that, when executed:
receives, from an external signing entity, a first cryptographically signed request to associate a unique digital object with a second memory address on the distributed digital ledger, the second memory address derived from a public cryptographic key associated with the external signing entity;
in response to the first cryptographically signed request, invokes, via an API function call, the metadata transformation API, wherein, executing the API function call, the metadata transformation API:
retrieves static metadata associated with the unique digital object,
transforms, in real-time, a virtualized computational power metric assigned to the unique digital object to mutable metadata for the unique digital object, and
stores the mutable metadata on the distributed ledger in association with the unique digital object thereby designating the unique digital object as an operating unique digital object capable of extracting digital resources from the distributional ledger based on the virtualized computational power metric described in the mutable metadata;
records, within the replicated application state, a resource allocation state for the unique digital object over a defined epoch interval, the resource allocation state representing an allocation value of a resource unit based on a proportion of the virtualized computational power metric relative to a total computational power metric associated with a plurality of digital objects;
receives, from the external signing entity, a second cryptographically signed request to initiate a resource unit transfer process for the unique digital object, the second request including an indication of a quantity of resource units to transfer; and
accesses, as part of the resource unit transfer process, the second memory address to update a total transferred quantity of resource units for the unique digital object based on the resource allocation state and the indicated quantity of resource units to transfer.

2. The distributed computing system according to claim 1, wherein the executable module is further configured to:
receive, from the external signing entity, a third cryptographically signed request indicating an updated value of the virtualized computational power metric;
modify the virtualized computational power metric with the updated value; and
record, within the replicated application state, a second resource allocation state for the unique digital object over a second defined epoch interval, the second resource allocation state representing a second allocation value of the resource unit based on a proportion of the updated virtualized computational power metric relative to a total computational power metric for the second defined epoch interval.

3. The distributed computing system according to claim 2, wherein the executable module is further configured to:
store the updated value of the virtualized computational power metric as a pending value within the replicated application state; and
verify that each resource unit allocated to the unique digital object in one or more epoch intervals preceding the second epoch interval have been transferred, wherein modifying the virtualized computational power metric with the updated value is based on the verifying.

4. The distributed computing system according to claim 1, wherein the executable module is further configured to:
receive, from the external signing entity, a third cryptographically signed request designating a secondary memory address as a designee address for the unique digital object;
store the designee address within the replicated application state in association with the unique digital object;
receive, from the external signing entity, a fourth cryptographically signed request to initiate an additional resource unit transfer process for the unique digital object, the fourth request including an indication of a second quantity of resource units to transfer; and;
access the designee address to update a total transferred quantity of resource units at the designee address for the unique digital object based on the indicated second quantity of resource units to transfer.

5. The distributed computing system according to claim 1, wherein recording the resource allocation state for the digital object comprises:
storing, within the replicated application state, each of:
a value of the total computational power metric for the defined epoch,
a value of the virtualized computational power metric for the defined epoch, and
a total quantity of resource units available for allocation during the defined epoch.

6. The distributed computing system according to claim 2, wherein the executable module is further configured to:
retrieve the resource allocation state from the replicated application state based at least in part on receiving the second cryptographically signed request;
determine a quantity of resource units available for transferring based on the value of the total computational power metric, the value of the virtualized computational power metric, and the total quantity of resource units available; and
record, within the replicated application state, a portion of the available quantity of resource units that are transferred as part of the resource unit transfer process based on the quantity of resource units indicated in the second request.

7. The distributed computing system according to claim 6, wherein the executable module is further configured to:
determine, based on the unique digital object becoming associated with the virtualized computational power metric during the epoch, a corresponding participation duration, wherein the quantity of resource units available for transferring is based at least in part on a ratio of the participation duration to a total duration of the epoch.

8. The distributed computing system according to claim 7, wherein the replicated application state comprises a respective value of the virtualized computational power metric for each of a plurality of unique digital objects associated with the defined epoch, and wherein the executable module is further configured to:
determine, for each unique digital object of the plurality of unique digital objects, a respective quantity of resource units available for transferring;
sum the respective quantity of resource units for each unique digital object of the plurality of unique digital objects to obtain an aggregate quantity of resources available for transferring;
determine a quantity of untransferable resource units based on a difference between the aggregate quantity of resources available for transferring and the total quantity of resources available for allocation during the defined epoch; and
record, in the replicated application state, the quantity of untransferable resource units.

9. The distributed computing system according to claim 1, wherein the distributed computing system further comprises a second executable module deployed on the distributed ledger, and wherein:
recording the resource allocation state comprises providing the resource allocation state to the second executable module; and
the executable module is further configured to:
retrieve, from the second execution module, the resource allocation state, wherein the resource unit transfer process is performed based at least in part on the retrieved resource allocation state.

10. The distributed computing system according to claim 1, wherein the second executable module is further configured to:
store, for each unique digital object of a plurality of unique digital objects, a data record comprising state data for the unique digital object;
store, for each defined epoch interval of a plurality of epoch intervals, a data record comprising state data for the epoch interval;
respond to read requests from the executable module to retrieve state data associated with a specific unique digital object or a specific defined epoch; and
retrieve and persist updates from the executable module.

11. The distributed computing system according to claim 1, wherein the distributed computing system further comprises a second executable module deployed on the distributed ledger, the second executable module configured to:
receive and store digitally signed configuration update requests from a predefined set of authorized computing addresses;
compare received configuration update requests to determine whether a threshold number of matching requests have been received for a particular configuration parameter; and
transmit, upon determining that the threshold has been met, an instruction to modify one or more parameter values stored in the replicated application state.

12. The distributed computing system according to claim 1, wherein the distributed computing system further comprises a second executable module deployed on the distributed ledger, wherein the second executable module is configured to:
receive a single digitally signed request comprising a batch of instructions for multiple unique digital objects;
verify the authenticity of the request using a cryptographic signature matching a predesignated signer address; and
decode and forward each instruction in the batch to the executable module for execution, each instruction including a digital object identifier and a corresponding operation type.

13. The distributed computing system according to claim 1, wherein the distributed computing system comprises a distributed application server operably coupled to the distributed ledger, the distributed application server configured to:
receive digitally signed input data from external computing devices;
construct and transmit one or more payloads to the executable module on the distributed ledger, the payloads formatted in accordance with the communication protocol of the distributed ledger and configured for execution by the peer computing devices;
retrieve application state data from the distributed ledger by invoking read-only functions exposed by the executable module; and
generate structured output data based on the retrieved application state.

14. The distributed computing system according to claim 1, wherein the distributed computing system further comprises a second executable module deployed on the distributed ledger, the second executable module configured to:
generate a new unique digital object and associate the new unique digital object with a target address specified in the input data;
transmit, to the executable module, data corresponding to the newly generated unique digital object, the data including an identifier of the unique digital object and an initial value of a virtualized computational power metric;
maintain, within the replicated application state, the initial value of the virtualized computational power metric for each generated unique digital object; and
provide, in response to a read request, encoded metadata for the unique digital object, the metadata comprising one or more attributes derived from values stored in the replicated application state.

15. The distributed computing system according to claim 1, wherein the consensus protocol is further configured to select a peer computing node for block generation based at least in part on a virtualized computational power metric associated with one or more unique digital objects registered within the system, wherein the executable module is further configured to:
evaluate the virtualized computational power metrics of a plurality of unique digital objects maintained in the replicated application state;
determine a weighted selection probability for each peer computing node based on its association with one or more unique digital objects; and
transmit a selection signal to the consensus protocol to initiate block generation by the selected peer computing node.

16. The distributed computing system according to claim 15, wherein transforming the virtualized computational power metric to mutable metadata comprises:
generating a structured metadata file that encodes the virtualized computational power metric in association with the unique digital object, wherein:
the structured metadata file is formatted as a machine-readable data structure stored at a memory address distinct from the memory address of the unique digital object, and
the executable module is configured to create a linkage between the memory address of the unique digital object and the memory address of the structured metadata file by recording a reference to the metadata address within the replicated application state.

17. A computer-implemented method in a distributed computing environment, the method comprising:
executing, by a plurality of peer computing nodes of a distributed ledger, a consensus protocol to maintain a replicated application state;
receiving, by an executable module stored at a first memory address on the distributed ledger and executed by the plurality of peer computing nodes via the consensus protocol, a first cryptographically signed request from an external signing entity to associate a unique digital object with a second memory address on the distributed ledger, the second memory address derived from a public cryptographic key associated with the external signing entity;
invoking, in response to the first cryptographically signed request and via an API function call, a metadata transformation application programming interface (API) in operable communication with the distributed ledger, wherein the invocation comprises:
retrieving static metadata associated with the unique digital object;
transforming, in real-time, a virtualized computational power metric assigned to the unique digital object into mutable metadata for the unique digital object; and
storing the mutable metadata on the distributed ledger in association with the unique digital object, thereby designating the unique digital object as an operating digital object capable of extracting digital resources based on the virtualized computational power metric described in the mutable metadata;
recording, within the replicated application state, a resource allocation state for the unique digital object over a defined epoch interval, the resource allocation state representing an allocation value of a resource unit based on a proportion of the virtualized computational power metric relative to a total computational power metric associated with a plurality of digital objects;
receiving, from the external signing entity, a second cryptographically signed request to initiate a resource unit transfer process for the unique digital object, the second request including an indication of a quantity of resource units to transfer; and
accessing, as part of the resource unit transfer process, the second memory address to update a total transferred quantity of resource units for the unique digital object based on the resource allocation state and the indicated quantity of resource units to transfer.

18. The method of claim 17, further comprising:
receiving, from the external signing entity, a third cryptographically signed request indicating an updated value of the virtualized computational power metric for the unique digital object;
modifying the virtualized computational power metric with the updated value; and
recording, within the replicated application state, a second resource allocation state for the unique digital object over a second defined epoch interval, the second resource allocation state representing a second allocation value of the resource unit based on a proportion of the updated virtualized computational power metric relative to a total computational power metric for the second defined epoch interval.

19. The method of claim 17, further comprising:
storing the updated value of the virtualized computational power metric as a pending value within the replicated application state; and
verifying that each resource unit allocated to the unique digital object in one or more epoch intervals preceding the second epoch interval has been transferred, wherein modifying the virtualized computational power metric with the updated value is based on the verifying.

20. A computer-program product comprising a non-transitory machine-readable storage medium storing computer instructions that, when executed by one or more processors, perform operations comprising:
executing, by a plurality of peer computing nodes of a distributed ledger, a consensus protocol to maintain a replicated application state;
receiving, by an executable module stored at a first memory address on the distributed ledger and executed by the plurality of peer computing nodes via the consensus protocol, a first cryptographically signed request from an external signing entity to associate a unique digital object with a second memory address on the distributed ledger, the second memory address derived from a public cryptographic key associated with the external signing entity;
invoking, in response to the first cryptographically signed request and via an API function call, a metadata transformation application programming interface (API) in operable communication with the distributed ledger, wherein the invocation comprises:
retrieving static metadata associated with the unique digital object;
transforming, in real-time, a virtualized computational power metric assigned to the unique digital object into mutable metadata for the unique digital object; and
storing the mutable metadata on the distributed ledger in association with the unique digital object, thereby designating the unique digital object as an operating digital object capable of extracting digital resources based on the virtualized computational power metric described in the mutable metadata;
recording, within the replicated application state, a resource allocation state for the unique digital object over a defined epoch interval, the resource allocation state representing an allocation value of a resource unit based on a proportion of the virtualized computational power metric relative to a total computational power metric associated with a plurality of digital objects;
receiving, from the external signing entity, a second cryptographically signed request to initiate a resource unit transfer process for the unique digital object, the second request including an indication of a quantity of resource units to transfer; and
accessing, as part of the resource unit transfer process, the second memory address to update a total transferred quantity of resource units for the unique digital object based on the resource allocation state and the indicated quantity of resource units to transfer.
